(19) United States
(12) Patent Application Publication
(10) Pub. No.: US 2026/0212485 A1
(43) Pub. Date: Jul. 23, 2026

(54) SEGMENTATION OF MULTIPLE INSTANCES OF A STRUCTURE USING VISION FOUNDATION MODEL

(71) Applicant: Carl Zeiss Microscopy GmbH, Jena (DE)

(72) Inventor: Jan-Philipp SIMEN, München (DE)

(73) Assignee: Carl Zeiss Microscopy GmbH, Jena (DE)

(21) Appl. No.: 19/452,503

(22) Filed: Jan. 19, 2026

(30) Foreign Application Priority Data
Jan. 20, 2025 (DE) 102025101915.0

(51) Int. Cl. G06T 7/00; G06T 7/12; G06T 7/70; G06V 10/74; G06V 10/762

(52) U.S. Cl. CPC G06T 7/0006; G06T 7/12; G06T 7/70; G06V 10/761; G06V 10/762; G06T 2207/30148

(57) ABSTRACT

Various examples pertain to processing an image depicting a plurality of instances of a structure such as a cell or a semiconductor structure. A segmentation model is prompted to provide segmentations of the instances, the segmentation model being trained across a plurality of domains including the technical or biological domain. A visual characteristic is determined at least for the instances based on an analysis of the image. The inference of the segmentation model is improved based on the visual characteristics.

### FIELD OF THE INVENTION

Various examples of the disclosure generally pertain to segmenting multiple instances of a structure depicted in an image using a vision foundation model.

### BACKGROUND OF THE INVENTION

Automated processing of images is widely applied across various use cases and domains. For instance, segmenting instances of a structure depicted in an image is widely employed, e.g., for processing of microscopy images or processing of satellite images.

There are models for segmentation known in the art that are tailored for segmenting instances of certain types of structures. In other words, domain-specific segmentation models are known in the art, e.g., for segmenting instances of certain cells or even certain cell types, segmenting semiconductor structures or even certain semiconductor structure types, etc. Segmentation of instances of other structure types for which the particular segmentation model has not been trained or parametrized fails or yields segmentations of insufficient accuracy. Such domain-specific segmentation models suffer from their limited ability of being applied to other domains. Certain variations in the appearance of the images or the structures themselves thus can lead to inferior quality of the segmentation results. This limits the ability for integration such domain-specific segmentation models into automated or semi-automated image analysis tasks.

To mitigate such limitations and shortcomings of domain-specific segmentation models, recently, machine-learned vision foundation models (VFM) have been used for segmentation tasks. See, e.g., Kirillov, Alexander, et al. “Segment anything.” Proceedings of the IEEE/CVF International Conference on Computer Vision. 2023. A VFM can be used to obtain segmentations of multiple instances of various structures across multiple domains. For this, the VFM has been trained based on training data sets including training samples across many domains. The training data sets are, accordingly, extremely large, e.g., include more than E7 or E8 sample images. For example, the VFM may have a transformer architecture.

In transformer architecture, input data is processed through layers that apply attention mechanisms to weigh the importance of different parts of the data at each step of the computation. This ability to focus on different parts of the data adaptively allows the architecture to be effective in handling the complexities found in diverse datasets that characterize tasks like image segmentation across multiple domains. Such an architecture may be composed of multiple stacked layers of attention and feed-forward neural networks, enabling it to learn rich and intricate data representations. Unlike convolutional neural networks (CNNs) that are often used for domain-specific vision models, transformers do not inherently process data in a hierarchical manner. Instead, they treat input data as a set of elements (such as pixels or patches of an image) to which they apply attention, allowing the model to weigh and prioritize different parts of the data based on the task at hand. For instance, the same VFM may be used in order to obtain segmentations of microscopic structures in the first image analysis task and can also be used to obtain segmentations of microscopic structures in a second image analysis task. However, due to their increased flexibility in segmenting various types of structures, these VFMs have greater complexity which typically results in additional context information being required for accurate prompting of the VFMs. Thus, control and prompting of such VFMs can cause additional workload. For instance, consider a scenario in which an image depicts multiple different types of structures. The image analysis task requires to provide segmentations of instances of a specific type of structure selected from the multiple types. Then, the VFM needs to be prompted to specifically provide segmentations for these particular instances, i.e., discriminating those instances against instances of other types of structures.

### SUMMARY OF THE INVENTION

Accordingly, a need exists for advanced techniques of processing images that depict a scene with a plurality of instances of the structure. In particular, a need exists for advanced techniques of processing images that mitigate or overcome at least some of the above-identified restrictions or drawbacks.

This need is met by the features of the independent claims. The features of the dependent claims define embodiments.

According to various examples, inference of a VFM is improved by additionally analyzing the image to determine a visual characteristic of a certain target structure for which multiple instances are to be segmented by the VFM. Such visual characteristic of a certain target structure can then be used in connection with the prompting of the VFM, e.g., by pre-filtering image positions at which the VFM is prompted. Alternatively or additionally, such visual characteristic of the certain target structure can also be used after inferring the VFM for post-filtering segmentations that are output by the VFM. In any case, such visual characteristic of the target structure can be used to obtain segmentations of a large number of instances of a certain structure without the need of manually providing a complex prompt to the VFM. For instance, it may suffice to annotate a single instance of the certain structure (or, at least, a small number of instances, e.g., less than 10 instances) to enable the VFM to provide segmentations for the large number of further instances of that structure.

A computer-implemented method of processing an image is disclosed. The image depicts a scene with a plurality of instances of the structure. The method includes obtaining location data from a user interface. The location data locates at least one selected instance of the plurality of instances of the structure in the image. The method also includes determining a visual characteristic of the at least one selected instance and, based on the visual characteristic of the at least one selected instance, determining further location data for each of multiple further instances of the structure. Then, based on that further location data, the VFM is prompted to obtain segmentations of the multiple further instances of the structure.

For instance, the image may be displayed to the user and the user may mark/annotate a given instance of those instances that are depicted in the image. Such marking may be implemented by clicking on the given instance with the mouse or by drawing a bounding box around that instance. A scribble annotation is another alternative.

These are examples of the location data that locates the at least one selected instance. The user may repeat such process for multiple instances; generally, the user may only manually locate a small fraction of all depicted instances.

As a general rule, segmentations obtained from the techniques disclosed herein may pertain to instance segmentations, delimiting different instances of a particular structure from each other. For instance, a respective segmentation mask may be provided for each instance. It would also be possible to obtain a segmentation mask that jointly discriminates all instances of a particular structure against background. For instance, a joint segmentation mask may be provided that marks all instances of the particular structure.

The location data does not need to have a level of detail that is comparable to the level of detail of a segmentation of the instance of the structure obtainable from the VFM. For instance, the location data may only roughly locate the instance of the structure in the image. The location data may overlap with background or even further instances of the structure or one or more instances of another structure. As such, the level of accuracy required by a user in providing the location data is relatively low, facilitating fast generation of the location data and tolerating errors or inaccuracies.

Then, based on such location data that locates the at least one selected instance, the visual characteristic is determined. The visual characteristic may equate to a characteristic fingerprint of the appearance of the structure in the image. In other words, the at least one selected instance can serve as a reference or template for finding further instances that have similar appearances. Visual characteristics may include, but are not limited to: texture; shape; size; geometry; etc.

The visual characteristic may be determined at the particular position in the image indicated by the location data. It would also be possible that, prior to calculating the visual characteristic, the particular position or region of the image used for determining the visual characteristic is determined based on the location data, e.g., by using a user-provided coarse or rough location indication (e.g., a scribble annotation) to determine a specific point or region (e.g., a point or box).

If multiple visual characteristics are determined for multiple selected instances, then an average of these visual characteristics can be determined and used for determining the further location data. Outliers of the visual characteristics may be removed.

As a general rule, various options are available for determining the visual characteristic. For instance, another model may be used to determine the visual characteristic. For instance, a machine-learned model may be used. A machine-learned image encoder may be used. Thereby, a feature vector representing the visual characteristic can be determined, the feature vector being defined in a machine-learned feature space. Such image encoder may be trained using auto-encoding. The image encoder may operate based on a respective image patch that is extracted from the image in accordance with the location data of the particular instance of the structure. For instance, the image patch may be centered at a center position associated with the image positions defined by the location data. Such image patch may have a predefined size; in such a scenario, the image patch may depict the particular instance of the structure, as well as background information and/or further instances of the structure or even other types of structure. The amount of information included in the patch beyond the respective instance of the structure is defined by the size of the patch. Nonetheless, since the task of determining visual characteristic is typically relatively simple (e.g., if compared to segmentation tasks) and/or may be trained using unsupervised training (e.g., as mentioned above, autoencoder techniques may be employed), despite using an image patch of a predefined size robust extraction of the visual characteristics remains possible.

Using a machine-learned encoder is only one option. Other options include analysis of an intensity in the respective image patch of the image, analysis of edge features in the respective image patch of the image, a texture analysis of a respective image pattern the image, a size of a respective structure, and/or shape of the respective structure. For example, the brightness histogram and/or the color histogram can be analyzed in a region defined by the location data that locates the respective instance. Such histogram information may serve as a characteristic fingerprint of the appearance of the structure in the image. Similar considerations also apply to edge features, e.g., edge shape and/or edge sharpness and/or edge thickness. Different types of structures may have different sizes and/or shapes.

Irrespective of the particular technique used for determining the visual characteristics of the selected at least one instance, determining each visual characteristic may include applying a dimensionality reduction algorithm to a respective feature vector. The dimensionality reduction algorithm may compress the respective feature vector, thereby obtaining a compressed representation of the feature vector. Such compression of a feature vector representing each visual characteristic may enable faster and/or more reliable search for further occurrences of instances of the structure.

Example dimensionality reduction algorithms include Principal Component Analysis, t-SNE, Uniform Manifold Approximation and Projection (UMAP) or similar. UMAP operates by representing high-dimensional data as a low-dimensional manifold, using a weighted graph to model similarity relationships between data points. A force-directed layout algorithm is then used to position the nodes in the low-dimensional space, simulating a physical system where nodes repel each other and edges attract each other. The result is a non-linear transformation that preserves the topology of the high-dimensional data, allowing UMAP to capture complex relationships and structure in the original data. PCA operates by identifying the directions of maximum variance in the data and projecting the data onto these directions, resulting in a lower-dimensional representation of the data. t-SNE, also known as t-distributed Stochastic Neighbor Embedding, is a non-linear dimensionality reduction algorithm that can be used to reduce the number of features or dimensions in high-dimensional data. t-SNE operates by modeling the similarities between data points using a Gaussian distribution and then mapping these similarities onto a lower-dimensional space.

The location data obtained from the user interface does not mark the positions of all instances of the structure, let alone a significant fraction of all instances of the structure. Hence, the further location data are determined that locate multiple further instances, typically a significant fraction of all instances of the structure depicted in the image or even all instances of the structure depicted in the image. Then, this further location data is used for prompting the VFM. The number of instances of the structure located by the further location data is larger than the number of instances located by the location data obtained via the user interface.

As a general rule, various options are available for determining the further location data for each of multiple further instances of the structure based on the visual characteristic of the at least one selected instance. For instance, a search can be executed across multiple image patches shifted across the image and for each of those image patches a match between the visual characteristic of the at least one selected instance and an associated candidate visual characteristic for a structure depicted by that particular image patch can be determined. If the match yields a sufficient agreement between the visual characteristic of the at least one selected instance and the associated candidate visual characteristic, then it may be concluded that at that particular image patch, a further instance of the particular structure is depicted. Determining of the further location data may, accordingly, include searching, across the image, for matches between the visual characteristic of the at least one selected instance and candidate visual characteristics of candidate instances of the structure and upon finding a match of the given image position adding the given image position to the further location data.

According to examples, the VFM may be prompted to obtain a further segmentation of the at least one selected instance based on the location data. The further location data for each of the multiple further instances of the structure can then be determined upon obtaining the further segmentation. Thus, in other words, it is possible to first obtain a template segmentation for the at least one selected instance and then make use of that template segmentation for the at least one selected instance when determining the further location data for each of the multiple further instances. For example, the visual characteristic of the at least one selected instance may be determined based on the template segmentation. This may enable separating background or other instances from the selected at least one instance of the structure when determining the visual characteristic. For instance, analysis of pixel values may be restricted for regions within that template segmentation of the at least one selected instance. In other words, when determining the visual characteristic, those pixel values may be neglected that are outside of the template segmentation of the selected instance. This enables separating background or other image information that should not impact the visual characteristic of the at least one selected instance of the structure used as a template for obtaining visual characteristic.

The method may include controlling the user interface to depict such template segmentation of the at least one selected instance and obtaining a confirmation of the template segmentation from the user interface. Then, determining of the further location data may be triggered by such confirmation. In other words, an interactive process may be implemented in which the user has a chance to confirm that the template segmentation determined for the at least one selected instance accurately reflects the appearance of the structure in the image. These techniques are based on the finding that since the selected at least one instance of the structure serves as a template for determining the further location data for many further instances of the structure, it is particularly important that the visual characteristic of each of the at least one selected instance are correctly determined. Otherwise, errors in determining the visual characteristics of the selected at least one instance would potentially propagate into inaccurate determination of the further location data and, subsequently, to inaccurate segmentations of the multiple further instances of the structure. Hence, such user-interactive process of validating the further segmentation initially obtained for the at least one selected instance that serves as the template can positively increase the robustness of locating and segmenting many further instances of the structuring of the image.

Above, various examples have been disclosed in which the location data that locates the at least one selected instance of the plurality of instances is obtained from a user interface. In other words, the location data positively locates the at least one selected instance, serving as a template for enabling the determination of segmentations for many other instances of a particular structure. Alternatively or additionally to obtaining such location data that positively locates the at least one selected instance, negative location data may be obtained from the user interface. The negative location data may indicate certain image positions that are free from any instances of the particular structure to be segmented. Thus, when determining the further location data it may be determined so that it does not include image positions that are adjacent to image positions included in the negative location data. On a more abstract level, alternatively or additionally to obtaining positive samples, negative samples may be obtained that annotate image positions or image regions that do not depict any instance of the particular structure to be segmented.

Above, various examples have been disclosed in which prior to prompting the VFM to obtain segmentations for multiple further instances of the structure, upstream processing is used to roughly locate those multiple further instances based on their visual characteristics. For instance, the further location data that is input to the VFM for obtaining segmentations of the multiple further instances of the structure may be the center point positions or bounding boxes. The VFM is then used to obtain the segmentations for the multiple further instances of the structure, the segmentations delimiting a circumference of each of the further instances.

Accordingly, leveraging such upstream processing based on the visual characteristic, the segmentations obtained from the VFM typically have a good quality and do not include, or only include to a limited degree, segmentations of instances of other structures or background. Nonetheless, even when applying such upstream processing for locating the multiple further instances prior to prompting the VFM, according to examples, a duplicate removal filter may be applied to the segmentations obtained from the VFM. Thereby, overlapping or duplicated segmentations of the same instance may be identified and consolidated. More generally, an output of the VFM may be validated and/or checked for integrity. For instance, a selection from segmentations obtained from the VFM may be performed. Thus, only a part of the segmentations may be retained and non-selected segmentations may be discarded, e.g., because they pertain to instances of other types of structures or to background. Non-selected segmentations may segment noise or clutter. The selection may be based on a cluster analysis of visual characteristics that are determined for each of the segmentations obtained from the VFM. Such cluster analysis may reveal a dominant cluster and only those segmentations that belong to that dominant cluster may be retained.

In a further example, a comparison may be executed between each of the segmentations output by the VFM and the initially determined one or more further segmentations determined for the at least one selected instance. For instance, it may be determined whether one or more geometrical properties of those segmentations output by the VFM match one or more properties of the one or more further segmentations. For instance, a comparison of size and/or shape may be executed.

Above, techniques have been disclosed in which upstream processing is used to pre-determine further location data for a large number of instances of the structure based on visual characteristics of at least one selected instance. Thus, the appearance of the structure in the image is analyzed and, using such upstream processing, it is determined where in the image respective occurrences of the structure can be found.

Then, the VFM can be inferred to provide segmentations for specific positions across the image at which, at high likelihood, a respective instance is located. Another approach is to shift such identification of the multiple instances of the structure from upstream processing, prior to inference of the VFM for further location data locating multiple instances of the structure, to downstream processing, i.e., after inference of the VFM. Then, post-filtering can be employed to only retain those segmentations that segment instances of that particular structure. Any segmentations that are associated with other types of structures or background or noise may be discarded. In other words, the output of the VFM is curated. Such techniques are explained next.

A computer-implemented method of processing an image is disclosed. The image depicts a scene with multiple instances of a structure. The method includes determining location data to include multiple image positions across the image. Then, based on the location data, the VFM is prompted to obtain candidate segmentations for multiple candidate instances at the multiple image positions. Based on the location data, visual characteristics of the multiple candidate instances are determined. Based on those visual characteristics of the multiple candidate instances, a selection from the candidate segmentations is performed, to thereby obtain segmentations of the multiple instances of the structure.

Here, non-relevant segmentations that pertain to instances of other structures or to background are initially obtained from the VFM and then discarded. These non-relevant segmentations are obtained because the logic involved in determining the location data can be comparatively simple, e.g., if compared to the logic described above in which the location data used for prompting the VFM is based on the visual characteristic of the at least one selected instance of the structure serving as a template.

Various options are available for determining the location data based on which the VFM is then prompted. In contrast to the techniques disclosed above, the location data is not determined based on the visual characteristic of at least one template instance of the structure. The location data may be determined based on an image analysis of the image. The image analysis may, e.g., include a peak detection analysis and/or an unsupervised image segmentation and/or a blob detection. For instance, local intensity maximums may be identified. Different types of structures may have appearances in the image that result in such local intensity maximums so that a differentiation between instances of the particular structure to be segmented and other types of structures cannot be attained by executing a peak detection analysis. An unsupervised image segmentation may provide such a differentiation between instances of different types of structures to some degree, albeit relatively unreliable. Blob detections may similarly yield location data for instances of manifold structures.

The location data may be determined based on an image analysis of the image, which can include partitioning the image into regions, referred to as “superpixels”, using an unsupervised segmentation algorithm. Examples of such algorithms include Normalized Cut, Quickshift, SLIC, and Watershed, among others.

Blob detection is a technique used in image analysis to identify and locate regions of interest within an image. Blob detection algorithms operate by analyzing the intensity patterns or texture features within an image to identify regions that are likely to contain instances of a particular structure. These regions are typically characterized by a high intensity or a specific texture pattern that is distinct from the surrounding background. Blob detection may operate based on Laplacian of Gaussian, Determinant of Hessian, or other similar techniques can also be used to partition the image into small regions. These methods can help identify regions of interest within the image that may correspond to instances of the structure to be segmented.

Once the image is partitioned into small regions, either the centroid of each region can be used as a point prompt or the bounding box around each region can be used as a box prompt. This location data can then be used to prompt the VFM to obtain candidate segmentations for multiple candidate instances at the multiple image positions.

Peak detection algorithms operate by analyzing the intensity patterns within an image to identify regions that exhibit high intensity values, which are often indicative of the presence of specific structures or features.

It is possible that one or more parameter settings of such image analysis algorithms are set by the user, e.g., an interactive process. For instance, the minimum distance between two peaks found by a peak detection analysis may be set by a user. For instance, a result of a certain setting may be depicted to the user and the user may responsive to such visual feedback have a chance of re-adjusting that setting. Thereby, without locating particular instances of the structure, the user still has an option of manually pre-filtering the positions marked by the location data that is then fed to the VFM.

While above a scenario has been disclosed in which the location data based on which the VFM is prompted is determined based on an image analysis, in other scenarios, the location data can be determined without analyzing the image content. For instance, the image positions included in the location data can include grid points of a grid. In other words, a grid may be superimposed on the image. A grid spacing may be predefined or may be determined based on prior knowledge on the particular structure to be identified. For instance, the grid spacing may be determined based on prior knowledge on a dimension of the instances of the structure is appearing in the image.

Irrespective of the particular technique of determining the location data based on which the VFM is subsequently prompted, it is possible that the output of the VFM includes overlapping or redundant segmentations. Accordingly, the method may include applying a duplicate removal filter to the candidate segmentations obtained from the VFM. The duplicate removal filter can operate by merging overlapping segmentations or selecting the most accurate segmentation based on certain criteria. Duplicate removal filters can be implemented using various algorithms and techniques. For example, a non-maximum suppression (NMS) filter works by suppressing segmentations that have a lower confidence score than the maximum confidence score in a local neighborhood. A greedy merge filter merges overlapping segmentations based on their similarity and spatial relationships. This filter starts with an initial segmentation and iteratively merges adjacent segmentations that have similar features or textures. Hierarchical clustering can also be used to group segmentations into a tree-like structure, where segmentations that are closest in the hierarchy are merged, resulting in a reduced number of segmentations. A spatial consistency filter removes segmentations that do not satisfy spatial consistency constraints, such as continuity or proximity. For instance, if two segmentations overlap but have different labels, the filter may remove one of them based on their spatial relationships. Feature similarity can also be used to remove segmentations that have similar features or textures, assuming that they correspond to the same instance of a structure. Optimization techniques, such as integer programming or linear programming, can be used to formulate the duplicate removal problem and solve it. This approach can be used to remove segmentations that do not satisfy certain constraints, such as spatial relationships or feature consistency. Machine learning algorithms can also be trained on a dataset of annotated images to learn a model that predicts whether two segmentations correspond to the same instance of a structure. This learned model can then be applied to new images to remove duplicates. Finally, distance-based techniques can be used to remove segmentations that are closer than a certain distance threshold, assuming that they correspond to the same instance of a structure.

Furthermore, even upon removing overlapping or redundant segmentations, the remaining segmentations may only partly be associated with instances of the particular structure to be segmented. In particular, the segmentations can also be associated with instances of other structures, e.g., other types of structures. For instance, when segmenting certain semiconductor structures, e.g., memory channels, in such a scenario, the segmentations may not only segment the memory channels, but also adjacent transistors, vias, or conductor structures. Those segmentations associated with other types of structures may need to be discarded or at least separated from the segmentations associated with the structure to be segmented. To achieve this, the selection is executed. The selection may be based on a cluster analysis of the visual characteristics of the multiple candidate structures. Cluster analysis can be performed using various algorithms and techniques, including but not limited to k-means clustering, hierarchical clustering, or density-based spatial clustering of applications with noise (DBSCAN). The choice of algorithm depends on the specific requirements and characteristics of the data. In the context of segmenting multiple instances of a structure, cluster analysis can be used to separate segmentations associated with different types of structures. For example, when segmenting certain semiconductor structures, e.g., memory channels, cluster analysis can be used to separate segmentations associated with memory channels from those associated with adjacent transistors, vias, or conductor structures. The output of the cluster analysis can be a set of clusters, each representing a group of segmentations that share common visual characteristics. These clusters can then be used to filter out segmentations associated with instances of other types of structures, resulting in a refined set of segmentations that are more likely to be associated with the particular structure to be segmented.

When determining the location data, it would also be possible to take into account negative location data. The location data can then be determined so that the multiple image positions included in location data are not adjacent to image positions included in the negative location data. To give a concrete example: location data may be determined to include all grid positions of a regular grid, except those grid positions that are adjacent to negative location data.

In the disclosed techniques, a respective visual characteristic can be determined for each of the candidate structures for which candidate segmentations are available. Techniques of determining such visual characteristics have been disclosed above and can be equally applicable in the presently discussed context. Then, a cluster analysis can be executed in order to determine clusters of candidate instances that exhibit similar visual characteristics. If multiple clusters are detected, a specific cluster may be selected by the user and/or based on prior knowledge on the appearance of the structure to be segmented. The cluster analysis may be an interactive cluster analysis that includes outputting a clustering result of an iteration of the cluster analysis via a user interface and obtaining a parameter setting of a further iteration of the interactive cluster analysis via the user interface. In other words, a user may be able to tune parameters of the cluster analysis in an interaction process. For instance, a user may set a cluster boundary delimiting two adjacent clusters. The user may be presented with an impact of such adjustment of a parameter setting, thereby being able to optimize the parameter setting based on such visual feedback.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates multiple images that can be processed according to various examples.

FIG. 2 is a flowchart of a method according to various examples.

FIG. 3 is a flowchart of a method according to various examples.

FIG. 4 schematically illustrates a scribble annotation in an image according to various examples.

FIG. 5A schematically illustrates a template segmentation in an image according to various examples.

FIG. 5B schematically illustrates an image patch in an image according to various examples.

FIG. 6 schematically illustrates further location data location image positions in an image for prompting a VFM according to various examples.

FIG. 7 illustrates segmentations obtained from a VFM according to various examples.

FIG. 8 is a flowchart of a method according to various examples.

FIG. 9A schematically illustrates multiple candidate segmentations obtained from a VFM according to various examples.

FIG. 9B schematically illustrates a cluster analysis according to various examples.

FIG. 10 is a schematic illustration of a processing device according to various examples.

### DETAILED DESCRIPTION OF THE INVENTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), a tensor processing unit (TPU), integrated circuits such as application-specific integrated circuits or field-programmable gate array (FPGA) circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

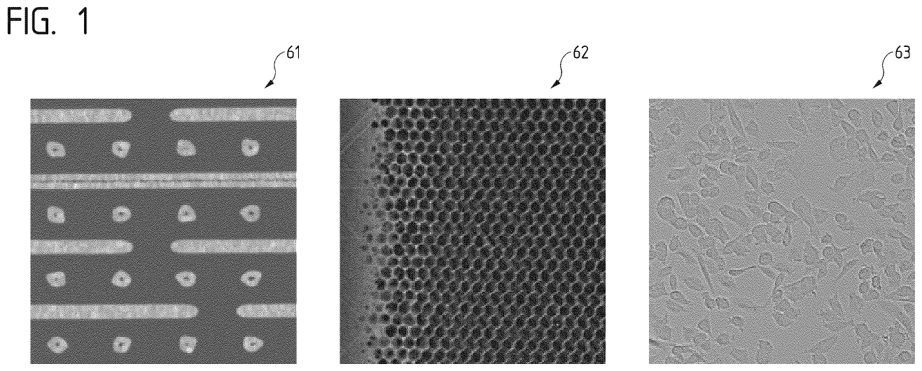

Hereinafter, techniques are disclosed to obtain segmentations for multiple instances of a structure depicted in an image. The techniques disclosed herein facilitate obtaining segmentations for a large number of instances of a structure, e.g., more than 50 instances, more than 500 instances, more than 5000 instances, or even more than 50,000 instances. Large images can be analyzed to determine respective segmentations. The techniques disclosed herein enable obtaining segmentations for various types of structures, e.g., cells of a biological sample, cf. FIG. 1: microscope image 63. For instance, certain types of cells can be segmented, e.g., transfected cells or living cells or dead cells or cells including one or more markers. Based on such segmentations of the cells, a cell confluency and/or a cell count may be determined. In another example, the multiple instances of the structure are semiconductor elements obtained from a lithography process, cf. FIG. 1: microscope image 61. Then, based on such segmentations a distribution of geometrical parameters across the semiconductor elements may be determined. For instance, large arrays of certain semiconductor elements, e.g., memory cells or channels, transistors, etc. may be present on a wafer or die upon executing the lithography process. Then, analysis of these arrays of semiconductor elements may enable automated benchmarking of the quality of the lithography process, e.g., by quantifying an inter-element parameter variation. Another use case that can benefit from the techniques disclosed herein is material testing. For instance, the multiple instances of the structure to be segmented may be structural elements of a patterned material, e.g., a woven material or a composite material, cf. FIG. 1, microscope image 62. Then, based on such segmentations a material property of the patterned material may be determined, e.g., a unit cell size, a unit cell size variation, elasticity, etc., to give only a few examples. In ecological studies, segmentation of plant leaves in drone-captured imagery of agricultural fields allows for monitoring health, detecting diseases, and optimizing yield. Here, each leaf is treated as a separate instance, and metrics such as surface area, color variation, or damage patterns are computed. In technical contexts, instance segmentation helps analyzing repetitive structures like rivets or bolts on an aircraft's fuselage in quality control inspections. Each rivet in an image is segmented as an instance, and parameters such as spacing, alignment, and structural integrity are analyzed to ensure compliance with safety standards. In medical imaging, the techniques disclosed herein can be applied to obtain segmentations of multiple anatomical features within a single image. For example, segmenting alveoli in lung tissue images can facilitate quantifying alveolar damage or morphological changes in diseases such as emphysema or fibrosis. Similarly, the segmentation of multiple glomeruli in kidney biopsies may enable automated determination of glomerular density and structural irregularities, aiding in the diagnosis and progression monitoring of nephropathies. In industrial settings, instance segmentation of grains or particles in metallographic images of materials, e.g., steel or alloys, allows for quantifying grain size, distribution, and boundaries. This enables assessing the mechanical properties of materials, such as hardness and tensile strength. For instance, large arrays of grains in a polished cross-section can be segmented, enabling the calculation of grain size distribution and detection of abnormalities such as inclusions or voids. In environmental monitoring, instance segmentation can be used to analyze coral polyps in underwater images. By segmenting each polyp, researchers can determine coral health, growth rates, and the impact of stressors like bleaching or pollution. Similarly, segmenting individual trees or canopy segments in satellite or drone imagery enables forest biomass estimation, carbon stock assessment, and deforestation monitoring.

In reference implementations of image processing techniques for obtaining respective segmentations, domain-specific models may be used for each of the above-identified use cases. In other words, different segmentation models may be employed for determining segmentations for different types of structures, e.g., for biological cells on the one hand and semiconductor elements on the other hand. While in some scenarios it may be acceptable to employ different models for completely different segmentation tasks—e.g., segmenting cells and segmenting semiconductor elements is unlikely to be implemented in the same laboratory of a workflow environment—, oftentimes even within a certain domain—e.g., segmenting semiconductor elements—a certain segmentation model may not be transferable to a slightly different task. For instance, a temporal drift may result in slightly deviating appearance of the nominally same semiconductor structure in a microscopy image and such deviating appearance may result in a need for retraining or fine-tuning a previously available segmentation model. In another example, slight changes to a mask layout of a lithography mask used in the lithography process may result in another appearance of certain structures in respective microscopy images, limiting the applicability of a pre-trained segmentation model to process these microscopy images. In all such scenarios, the disclosed scenarios provide a robust approach of segmenting multiple instances of a structure—limiting the problem of domain shift.

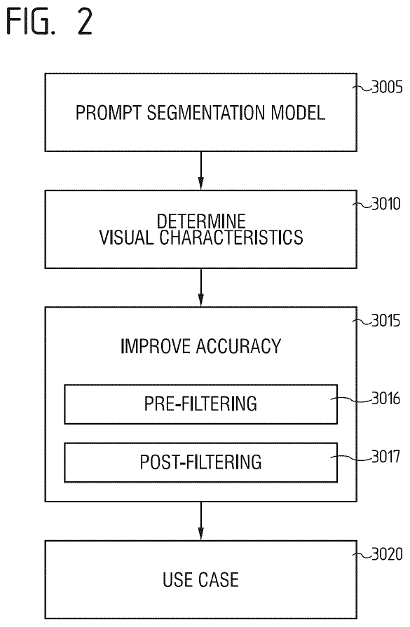

FIG. 2 is a flowchart of a method according to various examples. The method of FIG. 2 pertains to improvement of automated segmentation of multiple instances of a structure in an image, e.g., one of the images or image types according to FIG. 1. The method of FIG. 2 may be executed by a processing device. The method of FIG. 2 may be executed by a processor of a processing device, upon loading program code from a memory of the processing device and upon executing that program code.

In box 3005, a segmentation model is prompted based on location data. The location data may mark multiple positions across the image. For each position marked by the location data or positions or regions derived from the location data, the segmentation model is prompted to provide a respective segmentation including that particular position. The segmentation model may be a VFM trained across multiple domains, e.g., Segment Anything model as described by Kirillov et al.

The structure for which multiple instances are to be segmented by the segmentation model is defined in a certain technical or biological domain, e.g., cells, satellite images, materials, biological specimen, semiconductor structures, nanomaterials. The VFM is trained across many further domains, including that technical or biological domain of the particular imaging task, but also in other technical or biological domains.

The segmentation model may be inferred based on such prompt. Inference of the segmentation model may be executed locally or using cloud/server-side processing.

At box 3010, a visual characteristic associated with the appearance of the structure in the image is determined. The visual characteristic is determined based on the image. An image analysis may be executed.

The inference of the segmentation model is improved at box 3015, based on the visual characteristic of box 3010. For instance, improving the prediction accuracy at box 3015 may include pre-filtering image positions at which the segmentation model is prompted at box 3005 based on the visual characteristics, cf. box 3016. Alternatively or additionally, improving the prediction accuracy at box 3015 may include post-filtering segmentations that are output by the segmentation model based on the visual characteristics, cf. box 3017.

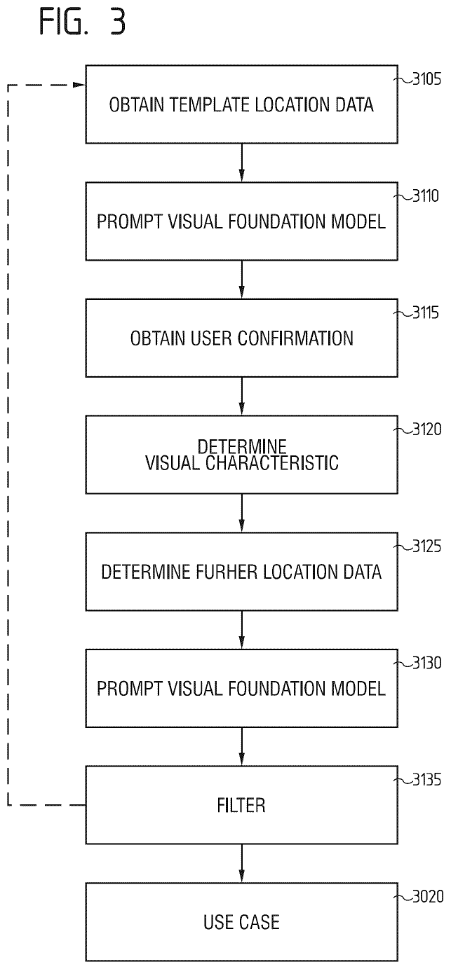

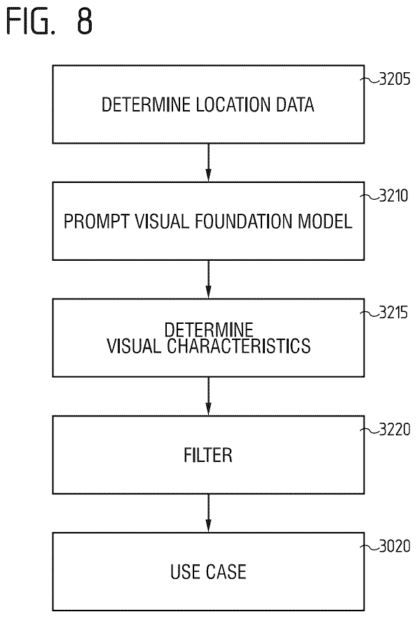

As will be noted, the sequence of boxes in FIG. 2 may deviate from the depicted illustration: for instance, when using a pre-filtering in accordance to box 3016, box 3010 and box 3016 may be executed prior to box 3005. Alternatively, if box 3017 is executed, the visual characteristics at box 3010 may be determined either prior to or after execution of box 3005. Details will be later on described in connection with FIG. 3 and FIG. 8.

At box 3020, a use case may operate based on the segmentations of the multiple instances of the structure/object. For instance, cell counting or cell confluency measurements may be executed. A transfection analysis may be facilitated. A distribution of geometrical parameters across multiple semiconductor elements may be determined. A material property of the pattern material may be determined. These are only some examples in further examples are conceivable. The segmentations can be used in many applications, like, for example, deriving the properties of each instance in the given image (size, shape, color, geometry, etc.) or training a machine learning model to segment unseen images.

FIG. 3 is a flowchart of a method according to various examples. The method of FIG. 3 pertains to improvement of automated segmentation of multiple instances of a structure in an image, e.g., one of the images or image types according to FIG. 1. The method of FIG. 3 employs a VFM for the segmentation. The method of FIG. 3 may be executed by a processing device. The method of FIG. 3 may be executed by a processor of a processing device, upon loading program code from a memory of the processing device and upon executing that program code. The method of FIG. 3 is an example implementation of the method of FIG. 2, specifically when box 3016 is executed.

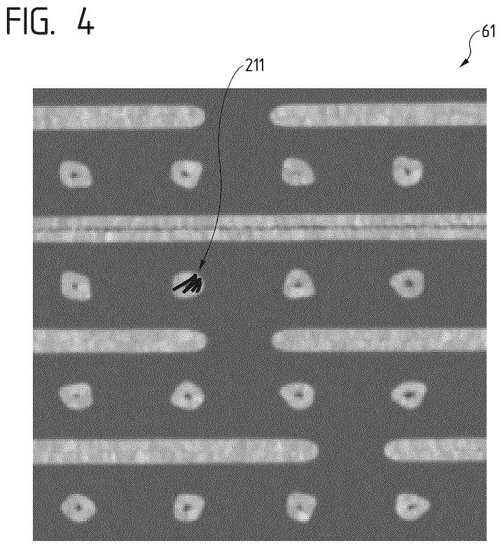

At box 3105, location data is obtained from a user interface. The location data that is obtained at box 3105 locates at least one selected instance of a plurality of instances of the structure depicted in the image. Thus, the location data may be referred to as template location data that locates at least one selected instance acting as a template. An example of such template location data 211 is illustrated in FIG. 4 for the microscope image 61. Here, the location data 211 equates to a scribble annotation of one of the memory channels in the microscope image 61. Other forms of location data are conceivable, e.g., bounding boxes or center point locations, to give just one example. A scribble annotation is only one example, in other examples include clicking on a specific instance or drawing a bounding box around a specific instance.

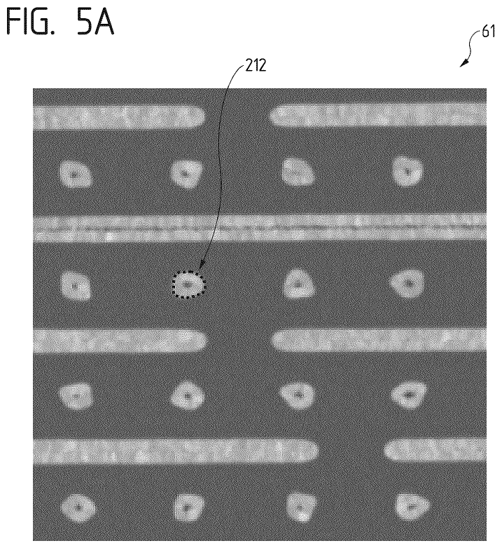

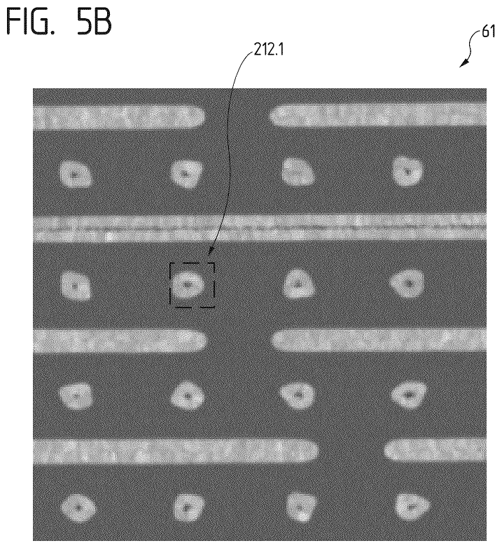

Now referring again to FIG. 3: It is optionally possible, at box 3110, to prompt the VFM, to obtain a segmentation of the at least one selected instance for which the template location data is obtained at box 3105. Accordingly, one or more templates segmentations may be obtained. This is also shown in FIG. 5A for the microscope image 61. Here, the template segmentation 212 for the particular memory channel that has been marked by the scribble annotation (cf. FIG. 4: location data 211) is illustrated by the dotted line.

Now referring again to FIG. 3: Optionally, at box 3115, a user confirmation for the one or more template segmentations may be obtained. Alternatively or additionally to obtaining such user confirmation, the user may also alter the one or more template segmentations, e.g., by extending or cropping.

Then, a visual characteristic of the at least one selected instance is determined at box 3120. This is in accordance with the template location data of box 3105. For instance, box 3120 may include analyzing pixel values of the image within the template segmentation. For instance, a size and/or shape of the template segmentation may be analyzed. For instance, a pixel value histogram of the pixel values within the template segmentation may be determined. An encoder branch may be used to determine a feature vector in a machine-learned feature space. It is not mandatory that a template segmentation such as the template segmentation 212 illustrated in FIG. 5A is determined, for determining the visual characteristic. In another example, the visual characteristic may be determined by analyzing pixel values in an image patch centered at a center position of the location data, cf. FIG. 5B where such image patch 212.1 centered at a center of the scribble location 211 of FIG. 4 is shown. For example, a pixel value brightness histogram may be determined across all pixels within that image patch 212.1, to give an example of a specific visual characteristic that may be considered. An image encoder may be executed on those pixel values in the image patch 212.1, the image encoder having been trained using unsupervised techniques, to obtain a respective feature vector.

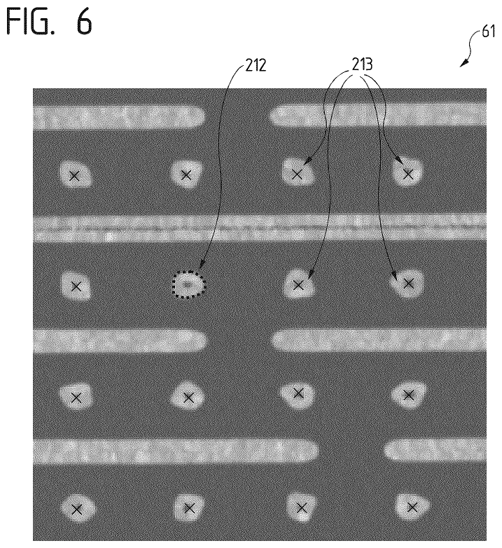

At box 3125, further location data is determined based on the visual characteristic of each selected instance. For instance, a search for matching visual characteristics can be executed across the image. A similarity measure such as Cosine Similarity may be used. Other similarity measures are possible, e.g., Euclidean distance or Manhattan distance, etc. This can be combined with a threshold comparison. For instance, a fixedly predefined threshold or a user-definable threshold may be used. A result of such search/match is shown in FIG. 6 for the microscope image 61. Here, the center point locations, illustrated in form of crosses, form the further location data 213, marking further instances of the memory channels.

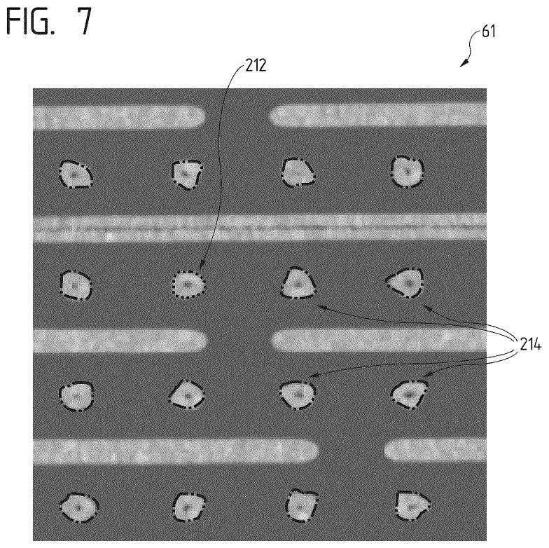

Referring again to FIG. 3: upon determining the further location data at box 3125, at box 3130, the VFM is prompted based on that further location data. Thereby, segmentations of the instances of the structure are obtained, as illustrated in FIG. 7 for the segmentations 214 (dashed-dotted lines).

Referring again to FIG. 3: it is optionally possible to post-filter, box 3135, the segmentations output by the VFM at box 3130. For instance, a duplicate removal filter and/or a selection from all output segmentations, e.g., based on a cluster analysis, can be executed. Filtering and merging of segmentation masks can be applied using non-maximum suppression (NMS) to remove duplicate or overlapping segmentations. NMS is a technique used in image processing to eliminate multiple detections of the same object or feature, resulting in a single, more accurate detection.

In the context of segmenting multiple instances of a structure, filtering and merging of segmentation masks using NMS can help refine the results obtained from the VFM. By removing duplicate or overlapping segmentations, NMS can improve the accuracy and precision of the final segmentations. The process of applying NMS to segmentation masks involves analyzing the overlap between different segmentations and selecting the most accurate one based on certain criteria, such as confidence scores or spatial relationships. This process can be repeated iteratively until no more duplicates or overlaps are found, resulting in a set of refined segmentations that accurately represent the instances of the structure.

NMS can be used in conjunction with other techniques, such as cluster analysis or feature extraction, to further refine the results obtained from the VFM. By combining these techniques, it is possible to obtain accurate and reliable segmentations of multiple instances of a structure in an image.

Optionally, at box 3135, each segmentation obtained from the VFM at box 3130 may be compared against the one or template segmentations obtained from box 3110. For instance, one or more geometrical parameters can be compared. The one or more geometrical parameter values deviate significantly, then respective segmentations output by the VFM may be discarded. Furthermore, one or more segmentations may be discarded that have an intersection with the initial one or template masks.

Then, box 3020 may be executed, as previously explained in connection with FIG. 2.

As will be appreciated, by executing box 3120 in conjunction with box 3125, the execution of the VFM is restricted to such positions across the image that, at a high likelihood, depict further instances of the particular target structure to be segmented. Accordingly, the predictions provided by the VFM are improved.

Certain modifications to FIG. 3 are possible. For instance, box 3105 through box 3135 may be iteratively repeated (indicated by dashed line in FIG. 3), wherein the template location data of a subsequent iteration of box 3105 is obtained as central points of segmentations output by a previous iteration of box 3135. Furthermore, in addition or as an alternative to obtaining positive location data that positively locates one or template instances at box 3105, negative location data may be obtained that negatively locates template instances at box 3105.

FIG. 8 is a flowchart of a method according to various examples. The method of FIG. 8 pertains to improvement of automated segmentation of multiple instances of a structure in an image, e.g., one of the images or image types according to FIG. 1. The method of FIG. 8 employs a VFM for the segmentation. The method of FIG. 8 may be executed by a processing device. The method of FIG. 8 may be executed by a processor of a processing device, upon loading program code from a memory of the processing device and upon executing the program code. The method of FIG. 8 is an example implementation of the method of FIG. 2, specifically when box 3017 is executed.

At box 3205, location data is determined. The location data may be determined based on an image analysis of the image, e.g., using peak-detection analysis, unsupervised image segmentation, and/or blob detection. Alternatively or additionally, the location data may be determined to comprise grid points of a predefined grid.

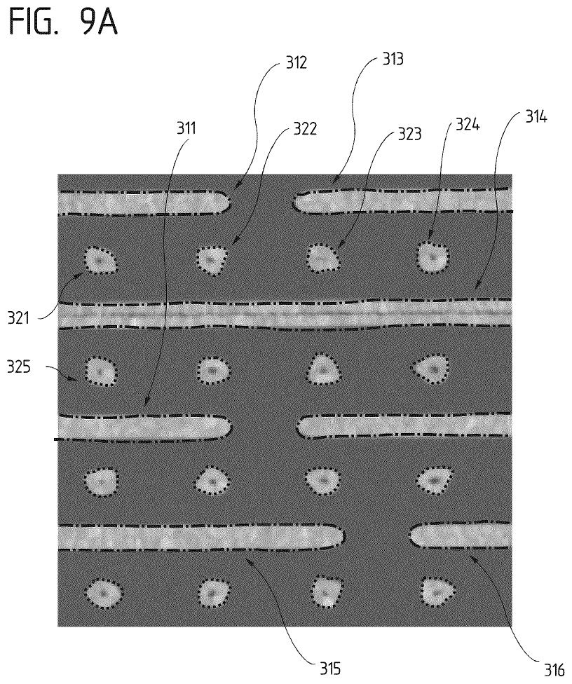

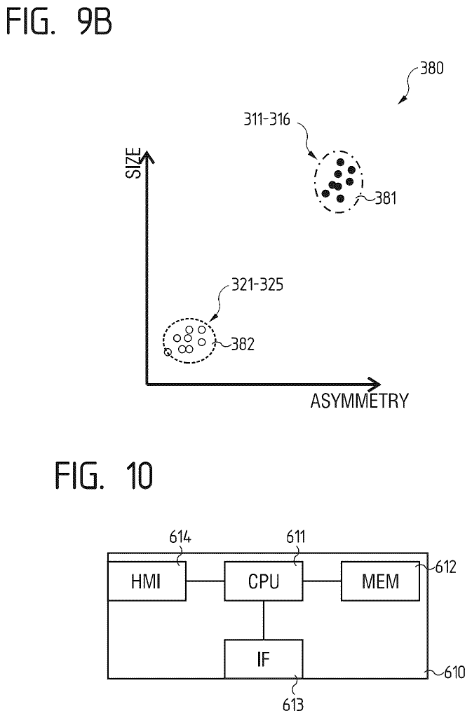

At box 3210, the visual foundation model is prompted based on the location data of box 3205; this yields multiple candidate segmentations for multiple candidate instances at multiple image positions associated with the location data of box 3205. For instance, multiple candidate segmentations are illustrated in FIG. 9A using dotted lines and dashed lines for two types of structures: the segmentations 311-316 delimited conductor structures; by the segmentations 321-325 (marked by dashed-dotted lines) delimit memory channels (not all segmentations of the memory channels are labeled in FIG. 9A; the segmentations are marked with dotted lines).

Referring again to FIG. 8: at box 3215, visual characteristics of the multiple candidate instances are determined. For instance, for each candidate segmentation, and associated visual characteristic can be determined. This may be implemented according to the techniques previously explained, e.g., using a machine-learned encoder branch, using an analysis of size and/or shape of the segmentations, analyzing pixel values within the segmentations, etc. to give only a few examples.

Then, at box 3220, based on the visual characteristics of the multiple candidate structures, a selection from the candidate instances can be performed, to thereby obtain segmentations of the multiple instances of the structure. In other words, some candidate segmentations 311-316 may be discarded/filtered based on such selection. Alternatively or additionally to analyzing pixel values within the segmentations, the visual characteristics may also be determined based on analysis of image patches that are aligned with or centered at such segmentations. For instance, referring to the scenario FIG. 9A, the candidate segmentations labeled with dashed-dotted lines may be discarded while the candidate segmentations labeled with dotted lines may be retained, as segmentations of the memory channel. Such discrimination may be effectively implemented using the shape and/or size of the segmentations. This may be achieved by implementing a cluster analysis. For instance, an output of the clustering result may be output to the user. The user may then select a particular set of candidate segmentations. An interactive cluster analysis may be executed. Alternatively or additionally, a duplicate removal filter may be applied in order to discard overlapping or redundant candidate segmentations. For instance, a duplicate removal filter and/or a selection from all output segmentations, e.g., based on a cluster analysis, can be executed. Filtering and merging of segmentation masks can be applied using non-maximum suppression (NMS) to remove duplicate or overlapping segmentations. NMS is a technique used in image processing to eliminate multiple detections of the same object or feature, resulting in a single, more accurate detection. In the context of segmenting multiple instances of a structure, filtering and merging of segmentation masks using NMS can help refine the results obtained from the VFM. By removing duplicate or overlapping segmentations, NMS can improve the accuracy and precision of the final segmentations. NMS can be used in conjunction with other techniques, such as cluster analysis or feature extraction, to further refine the results obtained from the VFM. By combining these techniques, it is possible to obtain accurate and reliable segmentations of multiple instances of a structure in an image.

For example, FIG. 9B illustrates a cluster analysis 380 for the segmentations 311-316, 321-325 illustrated in FIG. 9A. In the scenario FIG. 9B, the dimensions of the cluster analysis 380 are size and asymmetry of the respective segmentation 311-316, 321-325; however, as a general rule, other dimensions are possible. As illustrated in FIG. 9B, two clusters 381, 382 are formed that are well separated. Thereby, it becomes possible to make a selection for the segmentation 321-325, by selecting a respective region in the cluster-analysis space. In some scenarios, the various clusters formed are not well separated so that user interaction—e.g., to set certain properties of the cluster analysis itself and/or of the thresholding to select between different clusters, becomes helpful.

As will be appreciated, by executing box 3220, the outputs of the VFM are post-filtered (cf. FIG. 2: box 3017), thereby effectively improving the prediction result of the VFM. False segmentations pertaining to other structures that the targeted structure are removed.

Then, box 3020 may be executed, as previously explained in connection with FIG. 2.

FIG. 10 schematically illustrates a processing device 610 according to various examples. The processing device 610 includes a processor 611 as well as a memory 612 and a communication interface 613. The processor 611 can load the program code that is stored in the memory 612 and execute the program code. The processor 611, upon loading and executing the program code, performs techniques as disclosed herein, e.g., as described in connection with FIG. 2, or FIG. 3, or FIG. 8. For instance, the processor 611, upon loading and executing the program code, may load an image from an image database via the communication interface 613, load an image from the memory 612, process an image, e.g., by analyzing pixel values or executed one or more models or algorithms, communicate with a remote server via the communication interface 613, e.g., via the Internet, prompting a visual foundation model, e.g., locally executed by the processor 611 or executed by a remote server, obtaining segmentations from the visual foundation model, etc. The processing device 610 also includes a human-machine interface (HMI) 614. For instance, the HMI 614 can include a monitor and a mouse and a keyboard. An image including superimpose segmentations or annotations or markings can be output by the processor 611 via the HMI 640 for presentation to a user. The user may provide input such as providing location data that selects an instance of a plurality of instances of a structure in the image, providing a scribble annotation, drawing a bounding box or providing click selections. A user may set one or more parameters of an image processing via the HMI 614, e.g., may set one or more cluster parameters of a cluster analysis, may set one or more thresholds of a thresholding technique, to give just a few examples.

Summarizing, techniques have been disclosed that generally relate to segmenting multiple instances of a structure depicted in an image using a VFM.

The disclosed techniques facilitate obtaining segmentations for a large number of instances of a structure, such as cells of a biological sample, semiconductor elements obtained from a lithography process, or structural elements of a patterned material. The techniques enable automated segmentation of multiple instances of a structure across various domains, including biological, technical, and industrial contexts.

In an example implementation, location data is obtained from a user interface to locate at least one selected instance of the structure depicted in the image. A visual characteristic associated with the appearance of the structure in the image is determined based on the location data.

In various examples, a VFM is prompted based on location data.

In various examples a prediction provided by the VFM is improved by pre-filtering input data to the VFM and/or post-filtering output data provided by the VFM.

In various examples, it is possible to roughly locate multiple instances of the structure based on their visual characteristics, and then input such location data to the VFM to obtain a finer localization of the structures.

In some examples, a duplicate removal filter may be applied to the segmentations obtained from the VFM to remove overlapping or redundant segmentations.

In another example implementation, location data is determined based on an image analysis of the image, and the VFM is prompted based on the location data. Visual characteristics of the multiple candidate instances are then determined, and a selection from the candidate segmentations is performed to obtain segmentations of the multiple instances of the structure.

The disclosed techniques provide a robust approach to segmenting multiple instances of a structure, limiting the problem of domain shift, and enabling accurate and reliable segmentations across various domains.

Further summarizing, at least the following EXAMPLES have been disclosed.
EXAMPLE 1.A computer-implemented method of processing an image (61, 62, 63) depicting a plurality of instances of a structure, comprising:
obtaining (3105), from a user interface (614), location data (211) locating at least one selected instance of the plurality of instances of the structure in the image (61, 62, 63),
in accordance with the location data (211), determining (3125) a visual characteristic of the at least one selected instance, and
based on the visual characteristic of the at least one selected instance, determining further location data (213) for each of multiple further instances of the structure, and
based on the further location data (213), prompting (3130) a vision foundation model to obtain segmentations (214) of the multiple further instances of the structure.
EXAMPLE 2.The computer-implemented method of EXAMPLE 1, further comprising:
based on the location data, prompting (3110) the vision foundation model to obtain a further segmentation (212) of the at least one selected instance,
wherein the further location data for each of the multiple further instances of the structure is determined upon obtaining the further segmentation.
EXAMPLE 3.The computer-implemented method of EXAMPLE 2,
wherein the visual characteristic of the at least one selected instance is determined based on the further segmentation.
EXAMPLE 4.The computer-implemented method of EXAMPLE 3,
wherein the visual characteristic of the at least one selected instance is determined by analyzing pixel values of the image (61, 62, 63) within the further segmentation.
EXAMPLE 5.The computer-implemented method of any one of EXAMPLEs 2 to 4, further comprising:
controlling the user interface (614) to depict the further segmentation, and
obtaining (3115), from the user interface, a confirmation of the further segmentation,
wherein said determining of the further location data is triggered by the confirmation.
EXAMPLE 6.The computer-implemented method of any one of the preceding EXAMPLEs,
wherein said determining of the further location data comprises searching, across the image (61, 62, 63), for matches between the visual characteristic of the at least one selected instance and candidate visual characteristics of candidate instances of the structure, and upon finding a match at a given image position, adding the given image position to the further location data.
EXAMPLE 7.The method of any one of the preceding examples, further comprising:
obtaining (3105), from the user interface, negative location data,
wherein the further location data is determined so that it does not include image positions adjacent to image positions included in the negative location data.
EXAMPLE 8.The method of any one of the preceding EXAMPLEs, further comprising:
applying (3135) a duplicate removal filter to the segmentations obtained from the vision foundation model.
EXAMPLE 9.The computer-implemented method of any one of the preceding EXAMPLEs, further comprising:
performing (3135) a selection from the segmentations obtained from the vision foundation model,
wherein the selection is based on a cluster analysis of visual characteristics determined for each of the segmentations obtained from the vision foundation model.
EXAMPLE 10. A computer-implemented method of processing an image (61, 62, 63) depicting a plurality of instances of a structure, comprising:
determining (3205) location data to include multiple image positions across the image (61, 62, 63),
based on location data, prompting (3210) a vision foundation model to obtain candidate segmentations for multiple candidate instances at the multiple image positions,
determining (3125) visual characteristics of the multiple candidate instances, and
based on the visual characteristics of the multiple candidate instances, performing (3220) a selection from the candidate instances, to obtain segmentations of multiple instances of the structure.
Example 11. The computer-implemented method of EXAMPLE 10,
wherein the location data is determined based on an image analysis of the image (61, 62, 63).
EXAMPLE 12. The computer-implemented method of EXAMPLE 11,
wherein the image analysis comprises a peak detection analysis.
EXAMPLE 13. The computer-implemented method of EXAMPLE 11 or 12, wherein the image analysis comprises an unsupervised image segmentation.
EXAMPLE 14. The computer-implemented method of any one of EXAMPLEs 11 to 13,
wherein the image analysis comprises a blob detection.
Example 15. The computer-implemented method of EXAMPLE 10,
wherein the image positions included in the location data comprise grid points of a grid.
EXAMPLE 16. The computer-implemented method of any one of EXAMPLEs 10 to 15, further comprising:
applying a duplicate removal filter to the candidate segmentations obtained from the vision foundation model.
EXAMPLE 17. The computer-implemented method of any one of EXAMPLEs 10 to 16,
wherein the selection is based on a cluster analysis of the visual characteristics of the multiple candidate structures.
EXAMPLE 18. The computer-implemented method of EXAMPLE 17,
wherein the cluster analysis is an interactive cluster analysis comprising outputting a clustering result of an iteration of the cluster analysis via a user interface and obtaining a parameter setting for a further iteration of the interactive cluster analysis via the user interface.
EXAMPLE 19. The computer-implemented method of any one of EXAMPLEs 10 to 18, further comprising:
obtaining, from the user interface, negative location data,
wherein the location data is determined so that the multiple image positions included in the location data are not adjacent to image positions included in the negative location data.
EXAMPLE 20. The computer-implemented method of any one of the preceding EXAMPLEs,
wherein each visual characteristic is determined using a machine-learned image encoder operating on a respective image patch extracted from the image (61, 62, 63).
EXAMPLE 21. The computer-implemented method of any one of the preceding EXAMPLEs,
wherein each visual characteristic is determined based on at least one of: an analysis of an intensity in a respective image patch of the image (61, 62, 63); analysis of edge features in a respective image patch of the image (61, 62, 63); a texture analysis of a respective image patch of the image (61, 62, 63); a size of the respective structure; or a shape of the respective structure.
EXAMPLE 22. The computer-implemented method of any one of the preceding EXAMPLEs,
wherein each visual characteristic is determined by applying a dimensionality reduction algorithm to a respective feature vector.
EXAMPLE 23. The computer-implemented method of any one of the preceding EXAMPLEs, further comprising:
obtaining, from the user interface, negative location data,
wherein the vision foundation model is further prompted based on the negative location data.
EXAMPLE 24. The computer-implemented method of any one of EXAMPLEs 1 to 23,
wherein the multiple instances of the structure are cells,
wherein the method further comprises: based on the segmentations of cells, determining at least one of a cell confluency or a cell count.
EXAMPLE 25. The computer-implemented method of any one of EXAMPLEs 1 to 23,
wherein the multiple instances of the structure are semiconductor elements obtained from lithography,
wherein the method further comprises: based on the segmentations of the semiconductor elements, determining a distribution of geometrical parameters across the semiconductor elements.
EXAMPLE 26. The computer-implemented method of any one of EXAMPLEs 1 to 23,
wherein the multiple instances of the structure are structural elements of a patterned material,
wherein the method further comprises: based on the segmentations of the structural elements, determining a material property of the patterned material.
EXAMPLE 27. A method of obtaining improved segmentations of multiple instances of a structure in an image (61, 62, 63), the structure being defined in a technical or biological domain, the method comprising:
prompting a segmentation model to provide segmentations of the instances, the segmentation model being trained across a plurality of domains including the technical or biological domain,
determining a visual characteristic at least for the instances based on an analysis of the image (61, 62, 63), and
improving inference of the segmentation model based on the visual characteristics.
EXAMPLE 28. The method of EXAMPLE 27,
wherein said improving of the inference comprises post-filtering segmentations output by the segmentation model based on the visual characteristics.
EXAMPLE 29. The method of EXAMPLE 28,
wherein said improving of the inference comprising pre-filtering image positions with which the segmentation model is prompted based on the visual characteristics.
EXAMPLE 30. A processing device for processing an image depicting a plurality of instances of a structure, the processing device comprising a processor and a memory, the processor being configured to load program code from the memory and to execute the program code, the processor, upon executing the program code, being configured to:
obtain (3105), from a user interface (614), location data (211) locating at least one selected instance of the plurality of instances of the structure in the image (61, 62, 63),
in accordance with the location data (211), determine (3125) a visual characteristic of the at least one selected instance, and
based on the visual characteristic of the at least one selected instance, determine further location data (213) for each of multiple further instances of the structure, and
based on the further location data (213), prompt (3130) a vision foundation model to obtain segmentations (214) of the multiple further instances of the structure.
EXAMPLE 31. The processing device of EXAMPLE 30,
wherein the processor, upon executing the program code, is configured to execute the method of any one of EXAMPLEs 1 to 9 or 20 to 26.
EXAMPLE 32. A processing device for processing an image depicting a plurality of instances of a structure, the processing device comprising a processor and a memory, the processor being configured to load program code from the memory and to execute the program code, the processor, upon executing the program code, being configured to:
determine (3205) location data to include multiple image positions across the image (61, 62, 63),
based on location data, prompt (3210) a vision foundation model to obtain candidate segmentations for multiple candidate instances at the multiple image positions,
determine (3125) visual characteristics of the multiple candidate instances, and
based on the visual characteristics of the multiple candidate instances, perform (3220) a selection from the candidate instances, to obtain segmentations of multiple instances of the structure.
EXAMPLE 33. The processing device of EXAMPLE 32,
wherein the processor, upon executing the program code, is configured to execute the method of any one of EXAMPLEs 10 to 26.
EXAMPLE 34. A processing device for processing an image depicting a plurality of instances of a structure, the processing device comprising a processor and a memory, the processor being configured to load program code from the memory and to execute the program code, the processor, upon executing the program code, being configured to:
prompt a segmentation model to provide segmentations of the instances, the segmentation model being trained across a plurality of domains including the technical or biological domain,
determine a visual characteristic at least for the instances based on an analysis of the image (61, 62, 63), and
improve inference of the segmentation model based on the visual characteristics.
EXAMPLE 35. The processing device of EXAMPLE 34,
wherein the processor, upon executing the program code, is configured to execute the method of any one of EXAMPLEs 27 to 29.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

### REFERENCE NUMERALS

microscope image 61
microscope image 62
microscope image 63
location data 211
segmentation 212
image patch 212.1
location data 213
segmentation 214
segmentations 311-316
segmentations 321-325
processing device 610
processor 611
memory 612
communication interface 613
user interface 614
box 3005
box 3010
box 3015
box 3016
box 3017
box 3020
box 3105
box 3110
box 3115
box 3120
box 3125
box 3130
box 3135
box 3205
box 3210
box 3215
box 3220

What is claimed is:

1. A computer-implemented method of processing an image depicting a plurality of instances of a structure, comprising:
obtaining, from a user interface, location data locating at least one selected instance of the plurality of instances of the structure in the image,
in accordance with the location data, determining a visual characteristic of the at least one selected instance, and
based on the visual characteristic of the at least one selected instance, determining further location data for each of multiple further instances of the structure, and
based on the further location data, prompting a vision foundation model to obtain segmentations of the multiple further instances of the structure.

2. The computer-implemented method of claim 1, further comprising:
based on the location data, prompting the vision foundation model to obtain a further segmentation of the at least one selected instance,
wherein the further location data for each of the multiple further instances of the structure is determined upon obtaining the further segmentation,
wherein the visual characteristic of the at least one selected instance is determined based on the further segmentation,
wherein the visual characteristic of the at least one selected instance is determined by analyzing pixel values of the image within the further segmentation.

3. The computer-implemented method of claim 1,
wherein said determining of the further location data comprises searching, across the image, for matches between the visual characteristic of the at least one selected instance and candidate visual characteristics of candidate instances of the structure, and upon finding a match at a given image position, adding the given image position to the further location data.

4. The method of claim 1, further comprising:
obtaining, from the user interface, negative location data,
wherein the further location data is determined so that it does not include image positions adjacent to image positions included in the negative location data.

5. A computer-implemented method of processing an image depicting a plurality of instances of a structure, comprising:
determining location data to include multiple image positions across the image,
based on location data, prompting a vision foundation model to obtain candidate segmentations for multiple candidate instances at the multiple image positions,
determining visual characteristics of the multiple candidate instances, and
based on the visual characteristics of the multiple candidate instances, performing a selection from the candidate instances, to obtain segmentations of multiple instances of the structure.

6. The computer-implemented method of claim 5,
wherein the location data is determined based on an image analysis of the image.

7. The computer-implemented method of claim 5,
wherein the image positions included in the location data comprise grid points of a grid.

8. The computer-implemented method of claim 5, further comprising:
applying a duplicate removal filter to the candidate segmentations obtained from the vision foundation model.

9. The computer-implemented method of claim 5,
wherein the selection is based on a cluster analysis of the visual characteristics of the multiple candidate structures.

10. The computer-implemented method of claim 9,
wherein the cluster analysis is an interactive cluster analysis comprising outputting a clustering result of an iteration of the cluster analysis via a user interface and obtaining a parameter setting for a further iteration of the interactive cluster analysis via the user interface.

11. The computer-implemented method of claim 1,
wherein each visual characteristic is determined using a machine-learned image encoder operating on a respective image patch extracted from the image.

12. The computer-implemented method of claim 1,
wherein each visual characteristic is determined based on at least one of: an analysis of an intensity in a respective image patch of the image; analysis of edge features in a respective image patch of the image; a texture analysis of a respective image patch of the image; a size of the respective structure; or a shape of the respective structure.

13. The computer-implemented method of claim 1,
wherein each visual characteristic is determined by applying a dimensionality reduction algorithm to a respective feature vector.

14. The computer-implemented method of claim 1,
wherein the multiple instances of the structure are cells,
wherein the method further comprises: based on the segmentations of cells, determining at least one of a cell confluency or a cell count.

15. The computer-implemented method of claim 1,
wherein the multiple instances of the structure are semiconductor elements obtained from lithography,
wherein the method further comprises: based on the segmentations of the semiconductor elements, determining a distribution of geometrical parameters across the semiconductor elements.

16. The computer-implemented method of claim 1,
wherein the multiple instances of the structure are structural elements of a patterned material,
wherein the method further comprises: based on the segmentations of the structural elements, determining a material property of the patterned material.

17. A processing device for processing an image depicting a plurality of instances of a structure, the processing device comprising a processor and a memory, the processor being configured to load program code from the memory and to execute the program code, the processor, upon executing the program code, being configured to:
obtain, from a user interface, location data locating at least one selected instance of the plurality of instances of the structure in the image,
in accordance with the location data, determine a visual characteristic of the at least one selected instance, and
based on the visual characteristic of the at least one selected instance, determine further location data for each of multiple further instances of the structure, and
based on the further location data, prompt a vision foundation model to obtain segmentations of the multiple further instances of the structure.

18. A method of obtaining improved segmentations of multiple instances of a structure in an image, the structure being defined in a technical or biological domain, the method comprising:
prompting a segmentation model to provide segmentations of the instances, the segmentation model being trained across a plurality of domains including the technical or biological domain,
determining a visual characteristic at least for the instances based on an analysis of the image, and
improving inference of the segmentation model based on the visual characteristics.

19. The method of claim 18,
wherein said improving of the inference comprises post-filtering segmentations output by the segmentation model based on the visual characteristics.

20. The method of claim 19,
wherein said improving of the inference comprising pre-filtering image positions with which the segmentation model is prompted based on the visual characteristics.
